(19) United States
(12) Patent Application Publication
(10) Pub. No.: US 2024/0183968 A1
(43) Pub. Date: Jun. 6, 2024

(54) FMCW RADAR SYSTEM WITH SYNCHRONIZED VIRTUAL ANTENNA ARRAYS

(71) Applicant: Texas Instruments Incorporated, Dallas, TX (US)

(72) Inventors: Sandeep Rao, BANGALORE (IN); Karthik Subburaj, BANGALORE (IN); Karthik Ramasubramanian, Bangalore (IN)

(21) Appl. No.: 18/459,116

(22) Filed: Aug. 31, 2023

(30) Foreign Application Priority Data
Dec. 1, 2022 (IN) 202241069325

(51) Int. Cl. G01S 13/58; G01S 7/35

(52) U.S. Cl. CPC G01S 13/584; G01S 7/352; G01S 2013/0254

(57) ABSTRACT

In described examples, a frequency modulated continuous wave (FMCW) radar system comprises a first FMCW device that includes a first processor and a second FMCW device that includes a second processor. The first and second processors respectively receive first and second set of FMCW signals corresponding to a field of view (FOV), and—independently from each other—process the first and second sets of FMCW signals to respectively generate first and second sets of virtual antenna array signals. The second FMCW device transmits the second set of virtual antenna array signals to the first FMCW device. The first processor determines angle of arrival information with respect to one or more objects in the FOV in response to the first and second sets of virtual antenna array signals.

### CROSS-REFERENCE TO RELATED APPLICATION

This application claims the benefit of and priority to India Provisional Application No. 202241069325, filed Dec. 1, 2022, which is incorporated herein by reference.

### TECHNICAL FIELD

This application relates generally to frequency modulated continuous wave (FMCW) radar, and more particularly to use of virtual antenna arrays in an FMCW system to improve accuracy of object location determination.

### BACKGROUND

An FMCW radar transmits an electromagnetic radiation (EMR) signal with a known frequency that is modulated to vary up and down over time. The radar receives a reflected signal corresponding to the transmitted signal, and uses the received signal to determine presence, distance, angle of arrival, speed, and direction of movement of objects within a detection distance limit of the FMCW radar. Speed and direction of movement together correspond to a velocity of a detected object.

### SUMMARY

In described examples, a frequency modulated continuous wave (FMCW) radar system comprises a first FMCW device that includes a first processor and a second FMCW device that includes a second processor. The first and second processors respectively receive first and second sets of FMCW signals corresponding to a field of view (FOV), and—independently from each other—process the first and second sets of FMCW signals to respectively generate first and second sets of virtual antenna array signals. The second FMCW device transmits the second set of virtual antenna array signals to the first FMCW device. The first processor determines angle of arrival information with respect to one or more objects in the FOV in response to the first and second sets of virtual antenna array signals.

### BRIEF DESCRIPTION OF THE DRAWINGS

FIG. 1A is a graph of an example FMCW signal to be transmitted by an FMCW radar system.

FIG. 1B is a graph of an example data frame of FMCW signals to be transmitted by an FMCW radar system.

FIG. 2A is a diagram of an example Doppler division multiple access (DDMA) FMCW transmission.

FIG. 2B is a graph of an example received reflected FMCW signal corresponding to the DDMA FMCW transmission of FIG. 2A.

FIG. 3 is a functional block diagram of an example FMCW radar system for transmitting a DDMA FMCW transmission as shown in FIG. 2A, and receiving reflected FMCW chirps as shown in FIG. 2B.

FIG. 4 illustrates a process for determining range and velocity using FMCW chirps transmitted and received by the FMCW radar system of FIG. 3.

FIG. 5 illustrates a set of two dimensional fast Fourier transforms (FFTs) generated by applying the process of FIG. 4 to DDMA FMCW signals received by the first, second, third, and fourth receivers of FIG. 3.

FIG. 6 is a diagram of an example multiple-transceiver FMCW radar system 600.

FIG. 7A is a functional block diagram showing an example multiple-transceiver FMCW radar system with a shared reference clock.

FIG. 7B is a functional block diagram showing an example multiple-transceiver FMCW radar system 718 in which the first and second FMCW transceivers 702 and 704 each has a respective local reference clock that generates a reference clock signal.

FIG. 8 is an example process for performing object detection using the multiple-transceiver FMCW radar system of FIG. 7.

FIG. 9 is a set of graphs illustrating example differences between parameters of FMCW chirps to be transmitted by the multiple-transceiver FMCW radar system of FIG. 7.

### DETAILED DESCRIPTION

Herein, some structures or signals that are distinct but closely related have reference numbers that use a [number][letter] format, such as transmitters 206a, 206b, and 206c, and receivers 310a, 310b, 310c, and 310d. In some examples, these structures or signals are referred to generally, in the singular or as a group, using the [number] and without the [letter], such as the transmitters 206 and the receivers 310. Also, the same reference numbers or other reference designators are used in the drawings to designate features that are closely related structurally and/or functionally.

Herein, reference to transmitters and receivers herein refers to corresponding transmitting or receiving antennas. In some examples, antennas are located separately (such as on a different portion of a printed circuit board (PCB) from, and are electrically connected to, integrated circuits (ICs) that contain other portions of respective transmitter-related and receiver-related structure.

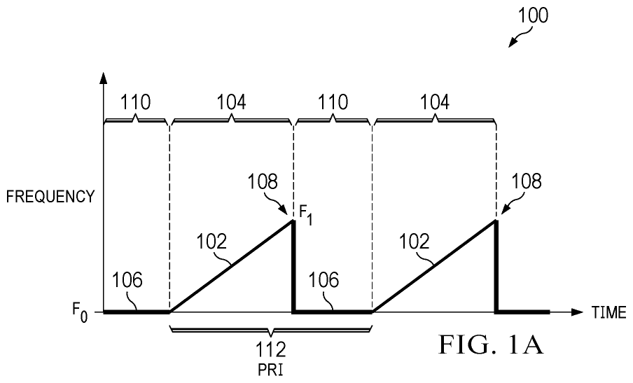

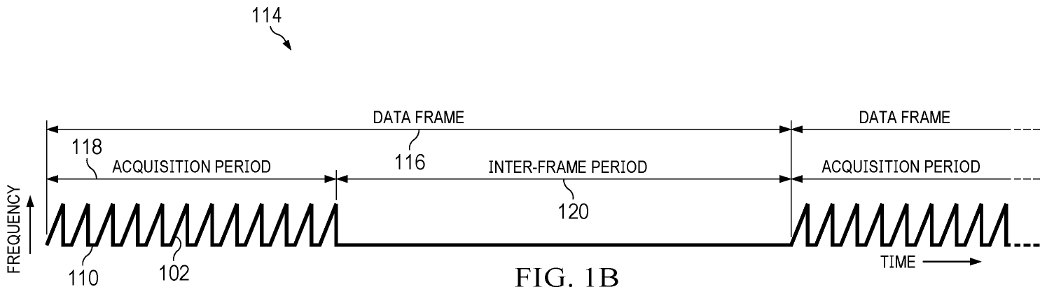

FIG. 1A is a graph of an example FMCW signal 100 to be transmitted by an FMCW radar system, such as an automotive or industrial FMCW radar system. The vertical axis corresponds to frequency, and the horizontal axis corresponds to time. The FMCW signal 100 is modulated to define FMCW chirps 102. The duration of an FMCW chirp 102 is referred to herein as the ramp time 104. During an FMCW chirp 102, the transmitter frequency may ramp upwards like a sawtooth wave, from a base frequency F₀ 106 to a maximum frequency F₁ 108. An FMCW chirp 102 has a slope S=(F₁−F₀)/ramp time. The slope of the FMCW signal 100 corresponds to a change in frequency per unit of time, for example, ΔHz/s. Between FMCW chirps 102 are idle times 110. An idle time 110 is a period during which a transmitter transmitting the FMCW signal 100 is turned off.

The time from the beginning of one FMCW chirp 102 to the beginning of the next FMCW chirp 102 of the same transmitter is referred to as the pulse repetition interval (PRI) 112 of the FMCW signal 100, and equals the ramp time 104 plus the idle time 110 of the transmitter. Equivalently, when interleaving chirps 102 from different transmitters with similar ramp 104 and idle times 110, the PRI 112 equals the number of transmitters in an FMCW radar system, multiplied by the total of the ramp time 104 for one FMCW chirp 102 plus the time from the end of the FMCW chirp 102 to the beginning of the sequentially next FMCW chirp 102 by another transmitter of the FMCW radar system (the ramp time 204 plus an inter-chirp time). In some examples, the duration of a PRI 112 defines a maximum discernable Doppler range. The inverse of the PRI 112 is the pulse repetition frequency (PRF) of the FMCW signal 100.

Fast time refers to the different time slots composing a PRI 112 during a single FMCW chirp 102, and may depend on the rate at which a received signal is sampled. Slow time updates after each PRI 112, and refers to time over the course of multiple FMCW chirps 102.

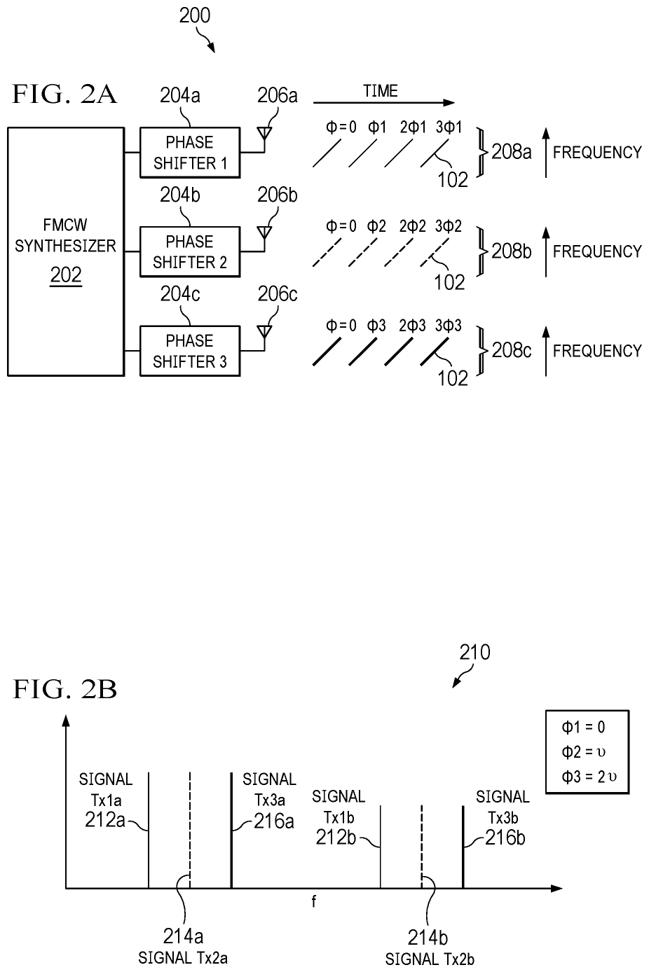

FIG. 1B is a graph 114 of an example data frame 116 of FMCW signals 100 to be transmitted by an FMCW radar system. A data frame 116 includes an acquisition period 118 and an inter-frame period 120. The acquisition period includes a series of FMCW chirps 102 from the various transmitters 206 (see FIG. 2A). During the inter-frame period 120, the transmitters 206 transmit no signal. In some examples, the inter-frame period 120 is used to conserve power, or to provide time to complete analysis of received reflected signals corresponding to the FMCW chirps 102 transmitted during the acquisition period 118.

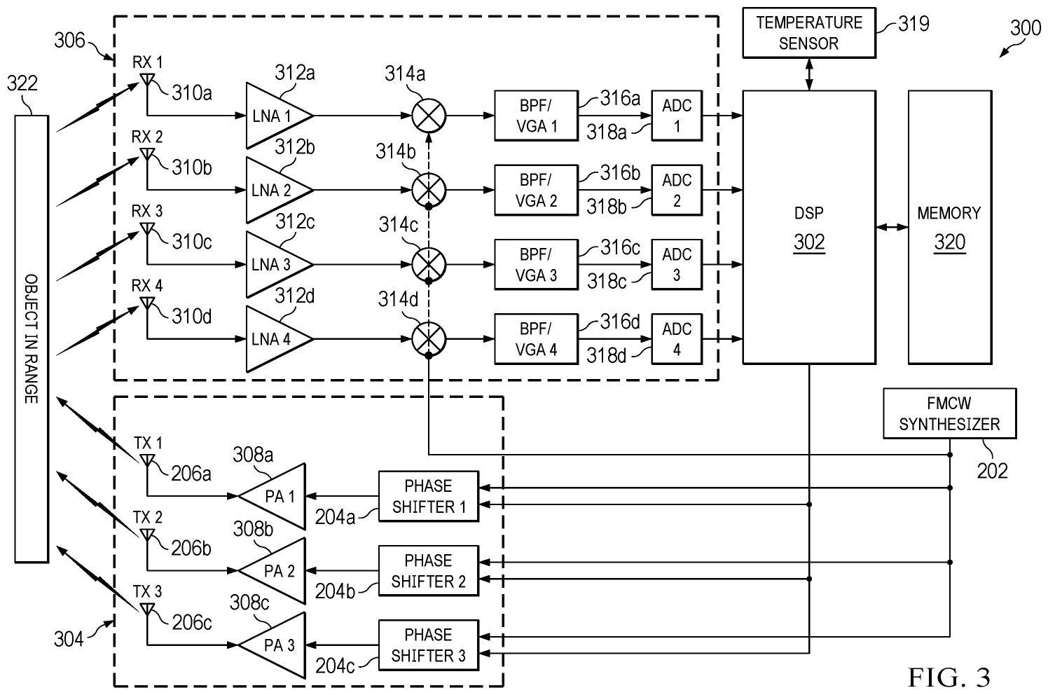

FIG. 2A is a diagram of an example Doppler division multiple access (DDMA) FMCW transmission 200. DDMA is used herein as an example transceiver protocol; other transceiver protocols, such as Time Division Multiple Access (TDMA) or Binary Phase Modulation, can also be used with methods and systems described herein. An FMCW synthesizer 202 (see FIG. 3, also referred to as an FMCW signal generator) generates an FMCW signal 100. The FMCW synthesizer 202 outputs the FMCW signal 100 to a first phase shifter (phase shifter 1) 204a, a second phase shifter (phase shifter 2) 204b, and a third phase shifter (phase shifter 3) 204c. The first phase shifter 204a outputs a phase shifted FMCW signal 100 to a first transmitter 206a. The second phase shifter 204b outputs a phase shifted FMCW signal 100 to a second transmitter 206b. The third phase shifter 204c outputs a phase shifted FMCW signal 100 to a third transmitter 206c.

Example FMCW chirps 102 are shown corresponding to each of the first transmitter 206a, the second transmitter 206b, and the third transmitter 206c. The FMCW synthesizer 202 and the first phase shifter 204a together generate a first set of chirps 208a. The FMCW synthesizer 202 and the second phase shifter 204b together generate a second set of chirps 208b. The FMCW synthesizer 202 and the third phase shifter 204c together generate a third set of chirps 208c.

To perform DDMA FMCW transmission, an FMCW signal, such as the FMCW signal 100 of FIG. 1, is phase shifted using phase shift coding that is differentiated in slow time (e.g., between sets of chirps) for different transmitters. In an example, a phase shift coding has sixty-four possible code settings, from zero to sixty-three. Individual code increments represent π/64 radians, so that phase shift ranges from zero radians to 2π*63/64^{ths} radians. Example phase shift code vectors include [0 16 32 48 0 16 32 48 0] and [0 24 48 8 32 56 16 40 0]. The first phase shift code vector increments by 16, and the second coding vector increments by 24. A phase shift increment corresponding to the code increment of a phase shift code vector is referred to herein as a base phase shift. After eight FMCW chirps 102, the two phase shift code vectors return to the same zero value phase offset, so that they periodically have the same value in fast time. However, the two vectors are differentiated over slow time.

In an example, base phase shift of the first, second, and third phase shifters 206a, 206b, and 206c are, respectively, ϕ1=0, ϕ2=0, and ϕ3=2υ, where υ is a phase shift corresponding to an integer code value. The transmitters 206a, 206b, and 206c transmit FMCW chirps that have been phase shifted using sequentially increasing multiples of respective base phase shifts. These increasing phase shifts cycle through respective phase shift code vectors.

A DDMA FMCW radar system can be used to implement a multiple-input multiple-output (MIMO) radar system. In a MIMO radar system with a number N transmitters and a number M receivers, the N signals transmitted by the transmitters are predictable and different across different transmitters. In some examples, in DDMA, transmitted signals are differentiated by applying unique Doppler shift sequences per transmitter to respective sets of FMCW chirps 102 to be transmitted. In TDMA, transmitted signals are differentiated by causing each transmitter to transmit signals within time slots that are unique with respect to the other transmitters. In Binary Phase Modulation, each transmitter has a unique phase sequence across slow time, corresponding to sequenced phase shifts of 0° or 180°, which enables signal recovery at the receivers.

A MIMO radar system as described, using signals differentiated across transmitters, enables N different signals to be extracted from each of the signals received by the M receivers, resulting in N×M different received signals, as if the MIMO radar system had N×M different receivers. This enables improved spatial resolution of the radar system. Doppler differentiation can be used to make the N transmitted signals predictable and unique using phase shift vectors that are differentiated from each other in slow time. Because of the property of being able to extract N×M different received signals, a MIMO radar system as described is referred to as having an N×M element virtual antenna array.

FIG. 2B is a graph of example Doppler shifts of received reflected FMCW chirps 210 corresponding to the DDMA FMCW transmission 200 of FIG. 2A. A horizontal axis corresponds to Doppler shift frequency and a vertical axis corresponds to amplitude. Doppler shift refers to a change in frequency of a signal received by an FMCW radar system (such as the FMCW radar system 300 of FIG. 3) with respect to a corresponding FMCW chirp 102 transmitted by the FMCW radar system. Doppler shifts are caused by relative motion of the FMCW radar system with respect to an object off which the received signal was reflected. FMCW chirps 102 that are transmitted at the same time as phase shifted copies of each other—same base frequency F₀ 106, same ramp time 104, and same maximum frequency F₁ 108—result in different Doppler shifts. In some examples, if the base phase shift is zero, then the Doppler frequency in a received reflected signal is dependent only on the velocity of the reflecting object. DDMA phase shifting results in Doppler frequencies that are unique per transmitter and that add to the inherent Doppler frequency shift that is dependent solely on velocity.

A Doppler shift of a first received signal (signal Tx1a) 212a corresponds to an FMCW chirp 102 of the first set of chirps 208a, transmitted by the first transmitter 206a. A Doppler shift of a second received signal (signal Tx2a) 214a corresponds to an FMCW chirp 102 of the second set of chirps 208b, transmitted by the second transmitter 206b. A Doppler shift of a third received signal (signal Tx3a) 216a corresponds to the third set of chirps 208c, transmitted by the third transmitter 206c. Signal Tx1a 212a, signal Tx2a 214a, and signal Tx3a 216a are shown grouped together, separated in frequency by relatively small increments corresponding to the separations in phase of the first set of chirps 208a, the second set of chirps 208b, and the third set of chirps 208c. Accordingly, signal Tx1a 212a, signal Tx2a 214a, and signal Tx3a 216a correspond to a first detected object.

Similarly, a Doppler shift of a fourth received signal (signal Tx1b) 212b corresponds to an FMCW chirp 102 of the first set of chirps 208a, transmitted by the first transmitter 206a. A Doppler shift of a fifth received signal (signal Tx2b) 214b corresponds to an FMCW chirp 102 of the second set of chirps 208b, transmitted by the second transmitter 206b. A Doppler shift of a sixth received signal (signal Tx3b) 216b corresponds to the third set of chirps 208c, transmitted by the third transmitter 206c. Signal Tx1b 212b, signal Tx2b 214b, and signal Tx3b 216b are shown grouped together, separated in frequency by relatively small increments corresponding to the separations in phase of the first set of chirps 208a, the second set of chirps 208b, and the third set of chirps 208c. Accordingly, signal Tx1b 212b, signal Tx2b 214b, and signal Tx3b 216b correspond to a second detected object.

FIG. 3 is a functional block diagram of an example FMCW radar system 300 for transmitting a DDMA FMCW transmission 200 as shown in FIG. 2A, and receiving reflected FMCW chirps 210 as shown in FIG. 2B. In some examples, a DDMA FMCW radar system, or an FMCW radar system using another type of transceiver protocol (such as TDMA or Binary Phase Modulation), uses different functional blocks. In some examples, the FMCW radar system 300 is configured to use millimeter wave sensing or sub-terahertz (sub-THz) sensing. In some examples, an FMCW radar system 300 that uses millimeter wave sensing transmits FMCW chirps 102 in a 60 gigahertz or 77 gigahertz band. In some examples, an FMCW radar system 300 that uses sub-THz sensing transmits FMCW chirps 102 in a 140 gigahertz (GHz) or higher band.

The FMCW radar system 300 includes an FMCW synthesizer 202, a digital signal processor (DSP) 302, a transmitter side 304, a receiver side 306, a temperature sensor 319, and a memory 320. The transmitter side 304 of the FMCW radar system 300 includes a first phase shifter (phase shifter 1) 204a, a second phase shifter (phase shifter 2) 204b, and a third phase shifter (phase shifter 3) 204c; a first power amplifier (PA1) 308a, a second power amplifier (PA2) 308b, and a third power amplifier (PA3) 308c; and a first transmitter (TX1) 206a, a second transmitter (TX2) 206b, and a third transmitter (TX3) 206c.

The receiver side 306 of the FMCW radar system 300 includes a first receiver (RX1) 310a, a second receiver (RX2) 310b, a third receiver (RX3) 310c, and a fourth receiver (RX4) 310d; a first low noise amplifier (LNA1) 312a, a second low noise amplifier (LNA2) 312b, a third low noise amplifier (LNA3) 312c, and a fourth low noise amplifier (LNA4) 312d; a first mixer 314a, a second mixer 314b, a third mixer 314c, and a fourth mixer 314d; a first band pass filter (BPF) and variable gain amplifier (VGA) circuit (BPF/VGA 1) 316a, a second BPF and VGA circuit (BPF/VGA 2) 316b, a third BPF and VGA circuit (BPF/VGA 3) 316c, and a fourth BPF and VGA circuit (BPF/VGA 4) 316d; a first analog-to-digital converter (ADC) circuit (ADC 1) 318a, a second ADC circuit (ADC 2) 318b, a third ADC circuit (ADC 3) 318c, and a fourth ADC circuit (ADC 4) 318d.

The FMCW synthesizer 202 generates FMCW chirps 102 to be transmitted, such as for object detection and range, angle, and velocity determination. The FMCW synthesizer 202 outputs the FMCW chirps 102 to respective first inputs of the first, second, and third phase shifters 204a, 204b, and 204c, and also to respective first inputs of the first, second, third, and fourth mixers 314a, 314b, 314c, and 314d. The first, second, and third phase shifters 204a, 204b, and 204c phase shift the FMCW chirps 102 using respective phase shift code vectors, as described with respect to FIG. 2A.

The first, second, and third phase shifters 204a, 204b, and 204c output the FMCW chirps 102 to, respectively, the first, second, and third power amplifiers PA1 308a, PA2 308b, and PA3 308c. The first, second, and third power amplifiers PA1 308a, PA2 308b, and PA3 308c amplify the respective phase shifted FMCW chirp signals, and output the amplified signals to, respectively, the first, second, and third transmitters 206a, 206b, and 206c. The first, second, and third transmitters 206a, 206b, and 206c transmit the amplified, phase shifted FMCW chirps. In some examples, the transmitted signals are reflected by an object 322 that is within the detection and range, angle, and velocity determination range of the FMCW radar system 300 (object in range 322).

The reflected signals are received by the first, second, third, and fourth receivers 310a, 310b, 310c, and 310d. The first, second, third, and fourth receivers 310a, 310b, 310c, and 310d output the received signals to, respectively, the first, second, third, and fourth low noise amplifiers LNA1 312a, LNA2 312b, LNA3 312c, and LNA4 312d, which amplify the received signals. The first, second, third, and fourth low noise amplifiers LNA1 312a, LNA1 312b, LNA1 312c, and LNA4 312d output the amplified signals to second inputs of, respectively, the first, second, third, and fourth mixers 314a, 314b, 314c, and 314d. The first, second, third, and fourth mixers 314a, 314b, 314c, and 314d output the mixed signals to, respectively, the first, second, third, and fourth BPF/VGA circuits 316a, 316b, 316c, and 316d, which filter and amplify the mixed signals. The first, second, third, and fourth BPF/VGA circuits 316a, 316b, 316c, and 316d output the resulting cleaned signals to, respectively, the first, second, third, and fourth ADC circuits 318a, 318b, 318c, and 318d, which sample the cleaned mixed signals to generate respective data sets made up of digital samples. The first, second, third, and fourth ADC circuits 318a, 318b, 318c, and 318d output the digital samples to the DSP 302 for analysis.

The DSP 302 uses the digital samples to determine presence, range, angle, and velocity of the object in range 322. Herein, object in range refers to an object that is both within a shared field of view (FOV) of FMCW transmitters 206 and corresponding FMCW receivers 310, and within a designed range over which a corresponding FMCW radar system (such as the FMCW radar system 300 of FIG. 3) can detect objects using received reflected FMCW signals.

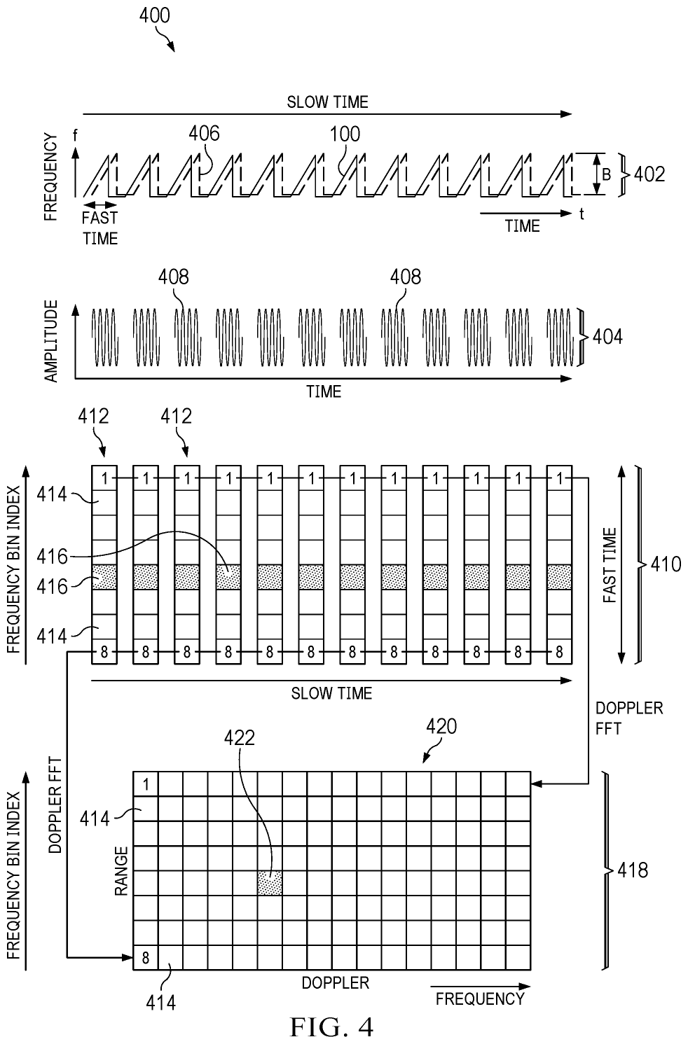

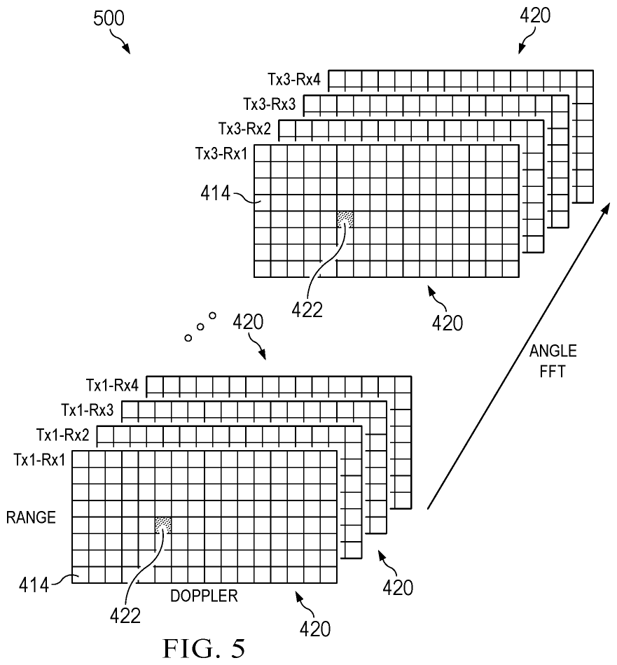

For example, presence of an object may be determined based on a signal amplitude greater than a threshold. Range may be determined by a unique range frequency corresponding to the signal's round trip delay multiplied by the FMCW chirp 102 slope. Velocity may be determined by the phase variation of the unique range frequency over multiple chirps, which manifests as a unique Doppler frequency. Angle may be determined by the phase variation for a particular received chirp across different receivers, caused by the difference in time of flight across the different receivers. These determinations are further discussed with respect to FIGS. 4 and 5.

FIG. 4 illustrates a process 400 for determining range and velocity using FMCW chirps 102 transmitted and received by the FMCW radar system 300 of FIG. 3. For step 402, the horizontal axis indicates time, and the vertical axis indicates frequency. For step 404, the horizontal axis indicates time, and the vertical axis indicates amplitude. The IF signal is the product of mixing the received signal with the transmitted signal. In step 402, an FMCW signal 100 is transmitted, and a received FMCW signal 406 is received. Individual FMCW chirps 102 are transmitted and received in fast time. The FMCW signal 100 is transmitted, and the received FMCW signal 406 is received, in slow time.

The amount of time for a transmitted signal to reach the object in range 322 equals d. The time for the reflected signal to return from the object in range 322 and be received by the first, second, third, and fourth receivers 310a, 310b, 310c, and 310d also equals d. Accordingly, the time of flight of an FMCW chirp 102 reflected by the object in range 322 is 2d. In some examples, the value of d varies in response to the distinct locations of different ones of the transmitters 306 and/or the distinct locations of the receivers 410. This varying value of d manifests in the signals received by the different receivers 410 as a phase variation that is used to perform angle estimation. Further, as discussed with respect to FIG. 2B, received FMCW chirps 102 are Doppler shifted relative to corresponding transmitted FMCW chirps 102 depending on motion of the FMCW radar system 300 relative to the object in range 322 from which the received FMCW chirps 102 are reflected, and depending on phase shift applied by a corresponding one of the first, second, or third phase shifter 204a, 204b, or 204c.

In step 404, the first, second, third, and fourth mixers 314a, 314b, 314c, and 314d mix (for example, multiply) respective received signals with the FMCW signal 100 generated by the FMCW synthesizer 202 to produce intermediate frequency (IF) signals 408. The frequency of the IF signal is linearly proportional to the time of flight, 2d, of the corresponding FMCW chirp 102. As described with respect to FIG. 3, the first, second, third, and fourth ADCs 318a, 318b, 318c, and 318d sample these IF signals after they are cleaned and amplified, and provide the resulting digital samples to the DSP 302 for analysis. In step 410, the DSP 302 performs a fast Fourier transform (FFT) on sets of the digital samples in fast time. This means that FFTs are determined for sets of samples of IF signals (received signals mixed with transmitted signals), so that the sets of samples are aligned to respective PRIs 112. This produces a series of one dimensional range FFTs 412 that are sequential in time.

The range FFTs 412 are divided into frequency bins 414. Each frequency bin 414 covers a separate Doppler shift frequency range and has an index indicating a range to the object and a value indicating a return signal strength associated with the respective range. The number of frequency bins 414 in respective range FFTs 412 corresponds to a frequency resolution of the FMCW radar system 300. Frequency resolution of the FMCW radar system 300 corresponds to range and velocity resolution of the FMCW radar system 300.

In the illustrated example, there are eight frequency bins 414 in each range FFT 412. In some examples, a range FFT 412 includes hundreds of frequency bins. If an object in range 322 is present, over a period of time, to reflect the transmitted FMCW chirps 102, there will be an amplitude spike 416. The amplitude spike 416 is shown in FIG. 4 as a shaded box in frequency bins 414 of the range FFTs 412. The amplitude spike 416 corresponds to the distance of the object in range 332 from the receiver (the first, second, third, or fourth receiver 310a, 310b, 310c, or 310d) that received the FMCW signal 100 being analyzed. The range FFTs 412 with this amplitude spike 416 correspond to the intermediate frequency indicating the presence of the object in range 322.

In step 418, the DSP 302 performs an FFT on the one dimensional range FFTs, in slow time. Accordingly, the DSP 302 performs an FFT on a temporally sequential set of the one dimensional range FFTs 412 to produce a two dimensional range-Doppler FFT 420. The range-Doppler FFT 420 includes a set of bins that each has (1) an index that represents a combination of range and velocity, and (2) a value indicating a return signal strength associated with the respective range and velocity. The range-Doppler FFT 420 covers a number of PRIs 112 determined in response to a designed velocity resolution; in some examples, this corresponds to one data frame 116. A vertical dimension of the range-Doppler FFT 420, corresponding to fast time (an individual PRI 112 with respect to a corresponding one of the transmitters 206), is divided into frequency bins 414 indicating range. The vertical dimension of the range-Doppler FFT 420 is also referred to as the range domain of the range-Doppler FFT 420. A horizontal dimension of the range-Doppler FFT 420, corresponding to slow time (across the selected number of PRIs 112), is divided into frequency bins 414 indicating Doppler shift. The horizontal dimension of the range-Doppler FFT 420 is also referred to as the Doppler domain of the range-Doppler FFT 420. In some examples, the selected number of PRIs 112 covers a few tens of milliseconds.

An amplitude spike 422 (darkened box) in the range-Doppler FFT 420 indicates the presence of an object in range 322. A vertical coordinate of the particular frequency bin 414 in which the amplitude spike 422 is located indicates the range of the object in range 322 from the FMCW radar system 300. A horizontal coordinate of the particular frequency bin 414 in which the amplitude spike 422 is located provides Doppler shift information. The Doppler shift information represented by the amplitude spike 422 in the range-Doppler FFT 420 can be used to determine the speed of the object in range 322 relative to the FMCW radar system 300. In an example, the determined speed is an average speed over the selected number of PRIs 112 used to generate the range-Doppler FFT 420.

FIG. 5 illustrates a set 500 of range-Doppler FFTs 420 generated by applying the process 400 of FIG. 4 to DDMA FMCW signals received by the first, second, third, and fourth receivers 310a, 310b, 310c, and 310d of FIG. 3. As described above, using differentiated phase shift vectors applied to the first, second, and third phase shifters 204a, 204b, and 204c in slow time enables FMCW signals 100 transmitted by a number N transmitters, and received by a number M receivers, to be treated as N×M separate received signals. For each of the M receivers, an object in range 322 will appear as N different peaks in the range FFTs 412. This increases the spatial resolution of the FMCW radar system 300.

The FMCW radar system 300 has three transmitters and four receivers. Accordingly, applying the process 400 to the FMCW radar system 300 results in twelve received signals, which can also be viewed as twelve objects to be resolved. A disambiguation step, also referred to as transmitter decoding, is performed to distinguish the twelve objects, and then the corresponding range FFTs 412 are processed to generate twelve range-Doppler FFTs 420. Different ones of the distinguished objects correspond to different combinations of the first, second, or third transmitter 206a, 206b, or 206c, and the first, second, third, or fourth receiver 310a, 310b, 310c, or 310d, so that different ones of the range-Doppler FFTs 420 correspond to different transmitter-receiver combinations. The range-Doppler FFTs 420 are identified according to the transmitter and the receiver to which they correspond. For example, a range-Doppler FFT 420 corresponding to the first transmitter (TX1) 206a and the third receiver (RX3) 310c is identified as TX1-RX3, and a range-Doppler FFT 420 corresponding to the third transmitter (TX3) 206c and the second receiver (RX2) 310b is identified as TX3-RX2.

As described above, by using range-Doppler FFTs 420 corresponding to multiple different receivers, an angle of the object in range 322 with respect to an orientation of the FMCW radar system 300 (angle of arrival) can be determined. In some examples, this is done by performing an FFT, referred to as an angle FFT, across the range-Doppler FFTs 420. For example, two receivers can be used to determine an angle in a single plane, which can be combined with a range to generate a two dimensional location of the object in range 322. For example, two receivers can be used to determine range and azimuth of the object in range 322. Similarly, three receivers can be used to determine angles in multiple planes, which can be combined with the range to determine a three dimensional location of the object in range 322. For example, three receivers can be used to determine range, azimuth, and elevation of the object in range 322.

An accuracy with which angle information of the object in range 322 is determined is limited by the number of antennas used to receive the reflected signals. In a MIMO radar system, this limitation corresponds to a number of virtual antennas in the virtual antenna array.

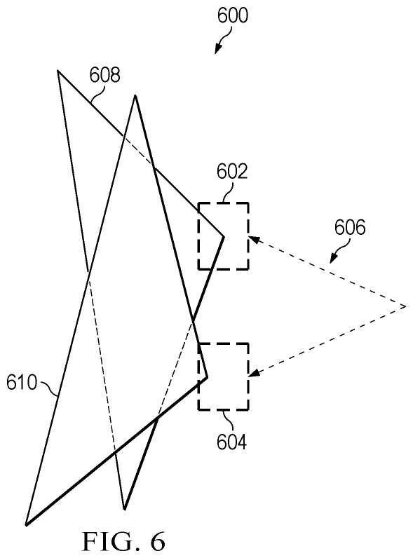

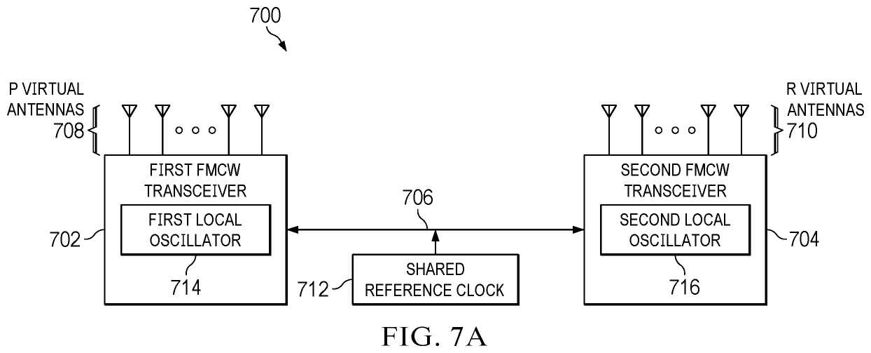

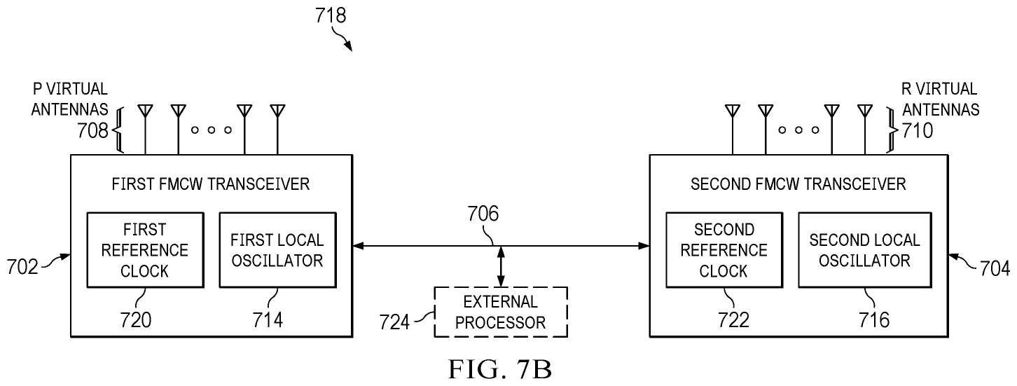

FIG. 6 is a diagram of an example multiple-transceiver FMCW radar system 600. The multiple-transceiver FMCW radar system 600 includes a first FMCW transceiver 602 and a second FMCW transceiver 604, which are connected by a communications interface 606. Herein, “FMCW transceiver” or “FMCW device” is used to refer to a device that includes structure (such as circuitry) for generation and transmission of FMCW chirps, reception of FMCW signals, and processing of FMCW signals. In some examples, the first FMCW transceiver 602 is physically separated from the second FMCW transceiver 604. As further explained with respect to FIG. 7. the first and second FMCW transceivers 602 and 604 are MIMO radar systems. The FMCW radar system 300 of FIG. 3 provides an example FMCW device that can be used to implement first FMCW transceiver 602 and/or the second FMCW transceiver 604.

The first FMCW transceiver 602 has a first FOV 608, and the second FMCW radar system 604 has a second FOV 610. The first and second FOVS 608 and 610 overlap. The first and second FMCW radar systems 602 and 604 use the communications interface 606 to synchronize FMCW chirp transmissions and share information about received signals to improve angle determination with respect to objects located within the region of overlap of the first and second FOVS 608 and 610, referred to herein as a shared FOV of the first and second FMCW transceivers 602 and 604.

FIG. 7A is a functional block diagram showing an example multiple-transceiver FMCW radar system 700 with a shared reference clock 712. The multiple-transceiver FMCW radar system 700 also includes a first FMCW transceiver 702 and a second FMCW transceiver 704, which are connected by a data communications line or bus 706. The first FMCW transceiver 702 includes a first local oscillator 714, and the second FMCW transceiver 704 includes a second local oscillator 716. The first and second local oscillators 714 and 716 generate respective, relatively high frequency reference signals, such as 20 GHz signals. These high frequency reference signals are used to generate respective FMCW chirps 102. The shared reference clock 712 generates a relatively low frequency reference signal, such as a 40 MHz signal. A synchronization pulse is also transmitted, such as from the shared reference clock 712 or from the first FMCW transceiver 702 to the second FMCW transceiver 704. The shared reference clock signal and synchronization pulse are used to enable automatic synchronization, across the first and second FMCW transceivers 702 and 704, of FMCW chirp parameters including start frequency, FMCW chirp slope, ADC start time, and inter-chirp time.

The first FMCW transceiver 702 includes a number P virtual antennas 708, as described with respect to FIG. 2A. The second FMCW transceiver 704 includes a number R virtual antennas 710. In some examples, the first FMCW transceiver 702 may be modeled as a leader circuit of the multiple-transceiver FMCW radar system 700, and the second FMCW transceiver 704 as a follower circuit of the multiple-transceiver FMCW radar system 700. Virtual antenna array synchronization as described herein, with respect to examples described according to FIGS. 7A and 7B, enables use of the first and second FMCW transceivers 702 and 704 to determine angle information with accuracy corresponding to a virtual antenna array with P+R virtual antennas. Virtual antenna array synchronization is performed using FMCW chirp parameter synchronization.

FIG. 7B is a functional block diagram showing an example multiple-transceiver FMCW radar system 718 in which the first and second FMCW transceivers 702 and 704 each has a respective local reference clock that generates a reference clock signal. The first FMCW transceiver 702 includes a first reference clock 720, and the second FMCW transceiver 704 includes a second reference clock 722. The first FMCW radar system 702 sends Ethernet-PTP timestamps and a frame synchronization pulse to the second FMCW transceiver 704, to enable virtual antenna synchronization according to the example FMCW radar system 714 of FIG. 7B. Virtual antenna array synchronization according to the example FMCW radar systems 700 and 714 of FIGS. 7A and 7B are further described below.

The first and second FMCW transceivers 702 and 704 transmit and receive FMCW chirp signals independently from each other. The first FMCW transceiver 702 processes its respective received FMCW chirp signals corresponding to its own transmissions, to generate virtual antenna array signals independently from the second FMCW transceiver 704. Similarly, the second FMCW transceiver 704 processes its respective received FMCW chirp signals corresponding to its own transmissions to generate virtual antenna array signals independently from the first FMCW transceiver 702. In some examples, processing FMCW chirp signals to generate virtual array signals includes performing range and Doppler FFTs, corresponding to steps 410 and 418 (as described above).

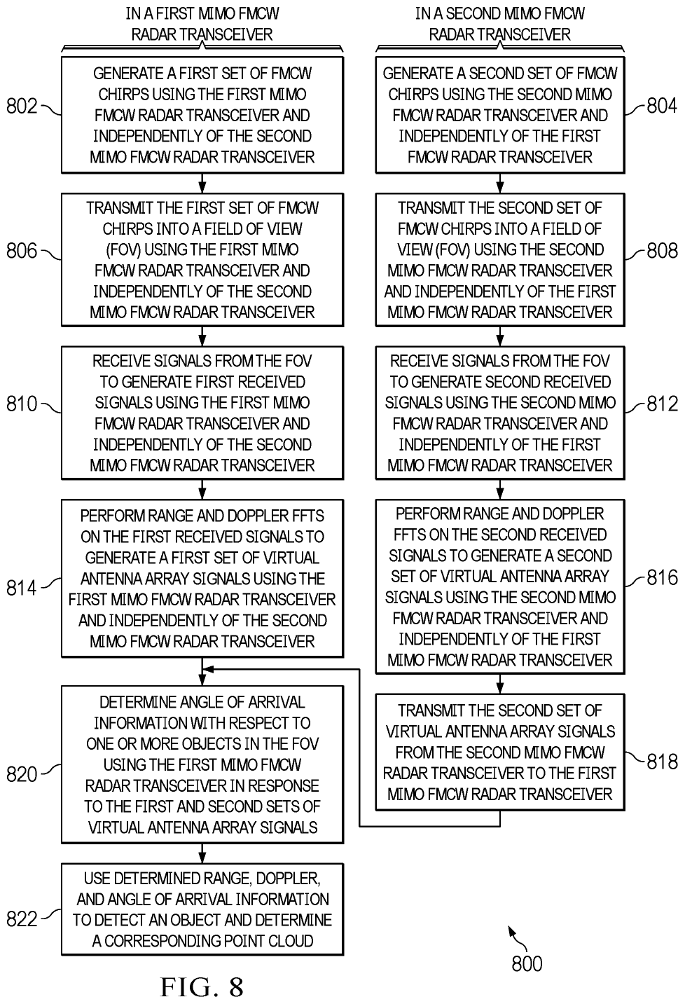

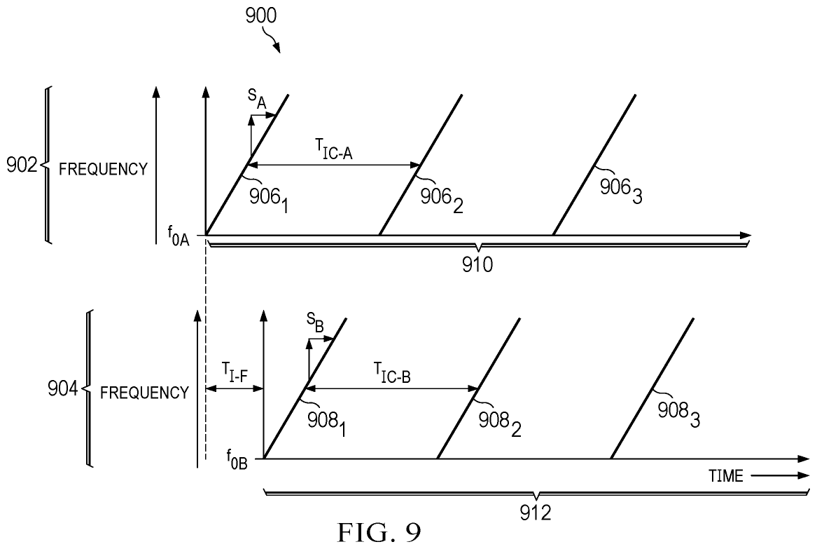

Once each device has generated signals corresponding to its own virtual antennas, the second FMCW transceiver 704 sends its virtual antenna information, such as its respective range-Doppler FFTs 420 for a data frame 116, to the first FMCW transceiver 702. (In some examples, range FFTs 412 are also provided.) The first FMCW transceiver uses the combined virtual antennas of the transceivers of the multiple-transceiver FMCW radar system 700 to perform angle estimation. This is enabled by synchronizing the first and second FMCW transceivers 702 and 704, and by avoiding interference between the first and second FMCW transceivers 702 and 704. This process is further described with respect to FIGS. 8 and 9.

The first and second FMCW transceivers 702 and 704 each use a reference clock signal—from the shared reference clock 712 or from the respective first or second reference clock 720 or 722—to provide a root timing for clocking and FMCW signal generation. Different frequency clocks for different functions (or groups of functions) are generated from the reference clock signal using phase locked loops (PLLs), frequency multipliers and dividers, and other frequency modification circuitry. Accordingly, in some examples, respective relatively high frequency local oscillators 714 and 716 are derived from the reference clock signal (from a shared or transceiver-specific reference clock) within the respective FMCW transceiver 702 or 704. In some examples, the shared reference clock signal or separate reference clock signals is (or are) used to generate clock signals to control and synchronize functions such as FMCW chirp 102 start frequency, inter-frame and inter-chirp timing, and analog-to-digital converter (ADC) start timing.

In some examples, it is unnecessary to transmit local oscillator signals between the first FMCW transceiver 702 and the second FMCW transceiver 704. In some examples (such as the example FMCW radar system 700 of FIG. 7A), a lower frequency reference clock signal, such as from the shared reference clock 712 or from the reference clock 720 of the first FMCW transceiver 702, is transmitted instead of the local oscillator signal. As described above, the frame synchronization pulse is also transmitted from the first FMCW transceiver 702 to the second FMCW transceiver 704. The frame synchronization pulse is used to synchronize the start of a data frame 116 in the second FMCW transceiver 704 with the start of a corresponding data frame 116 in the first FMCW transceiver 702. In some examples, synchronizing the starts of data frames 116 means to align them so that one begins at a fixed offset with respect to the other. This fixed offset is used to enable time differentiation between FMCW signals of the first FMCW transceiver 702 with respect to FMCW signals of the second FMCW transceiver 704, as further described below.

A relatively lower frequency reference clock signal may be used to synchronize FMCW chirp 102 transmission and processing by the first and second FMCW transceivers 702 and 704, avoiding phase offset error, because each of the first and second FMCW transceivers 702 and 704 independently processes signals it receives corresponding to FMCW chirps 102 it transmitted to generate its own respective virtual antenna array signals. Upconversion of a lower frequency reference clock signal to a higher frequency local oscillator can result in phase noise. A phase offset between FMCW chirps 102 transmitted by the first FMCW transceiver 702 and FMCW chirps 102 transmitted by the second FMCW transceiver 704 can also result in phase noise. Mixing of the transmitted and received signals by the mixers of the respective transceivers 702 and 704 cancels out the described phase noise because each of the transceivers 702 and 704 processes (to generate range and range-Doppler FFTs 412 and 420, that is, virtual antenna array signals) only received reflected signals corresponding to FMCW chirps 102 transmitted by the respective transceiver 702 or 704.

In other words, the first FMCW transceiver 702 transmits signals, receives signals corresponding to its own transmitted signals, and processes those corresponding signals independently of other signals it may receive to generate IF signals and virtual antenna array signals. The first FMCW transceiver 702 generates FMCW chirps 102 to be transmitted using the local oscillator of the first FMCW transceiver 702. The second FMCW transmitter 704 similarly, independently, generates its own IF and virtual antenna array signals using its own local oscillator. This independent activity enables relaxation of synchronization timing requirements.

Independent processing of the first and second FMCW transceivers 702 and 704 can be maintained by differentiating the transmitted signals of the first FMCW transceiver 702 from the transmitted signals of the second FMCW transceiver 704. Differentiation prevents interference between the different sets of signals, enabling transceivers to separate received (reflected) signals corresponding to respectively transmitted signals from received signals corresponding to transmissions by other transceivers. Differentiation between transmitted sets of signals can be performed by, for example, staggering in time transmissions of the first FMCW transceiver 702 from transmissions of the second FMCW transceiver 704 to prevent overlap in the intermediate frequency (IF) domain (see step 404). In some examples, this time differentiation can be adjusted for in post-processing using Doppler based phase compensation (also referred to herein as Doppler compensation).

In some examples, time separation of a few microseconds is sufficient to effectuate differentiation. In some examples, differentiation can be performed using Doppler division multiplexing or another signal differentiation technique.

In some examples, Doppler compensation is used to adjust for time differentiation as follows. Let C represent a complex number corresponding to a particular virtual antenna (for example, a range bin 414 of a range-Doppler cell 412). Doppler compensation is performed by multiplying C by e^{-j4πυT}^{_{I-F/}}^{λ}. Here, λ is the wavelength corresponding to a center frequency of the FMCW chirp 102 signal, T_{I-F} is a difference between the start time of a data frame 116 of the first transceiver 702 and a start time of a data frame 116 of the second transceiver 704, and v is the relative velocity of the target corresponding to the range-Doppler cell 422. In some examples, Doppler compensation is only performed on the virtual antennas 710 of the second FMCW transceiver 710. Doppler compensation is used to adjust for phase shift in the virtual antennas 710 of the second FMCW transceiver 704 caused by motion of an object in range 322 during the time gap between the respective start times of data frames 116 of the first and second FMCW transceivers 702 and 704.

In some examples, timestamps or other start time and end time signals generated with respect to a reference clock signal are used, along with the synchronization pulse, to synchronize functions of the first and second FMCW transceivers 702 and 704 such as FMCW chirp 102 start frequency, inter-frame and inter-chirp timing, and ADC start timing. In some examples, these signals are transmitted from the first FMCW transceiver 702 to the second FMCW transceiver 704. In some examples, these signals are transmitted from an external processor 724 (other than a processor within the first or second FMCW transceiver 702 or 704) to the first and second FMCW transceivers 702 and 704. In examples that use the external processor 724, both the first and second FMCW transceivers 702 and 704 perform synchronization as described with respect to the second FMCW transceiver 704 in the description below with respect to FIGS. 8 and 9. In some examples, the first and second FMCW transceivers 702 and 704 transmit independently determined virtual antenna array signal information to the external processor 724 for determination of angle information. Dotted lines are used to indicate that the external processor 724 corresponds to an alternative example implementation.

FIG. 8 is an example process 800 for performing object detection using the multiple-transceiver FMCW radar system 700 of FIG. 7. In step 802, the first MIMO FMCW radar transceiver 702 generates a first set of FMCW chirps independently of the second MIMO FMCW radar transceiver 704. In step 804, the second MIMO FMCW radar transceiver 704 generates a second set of FMCW chirps independently of the first MIMO FMCW radar transceiver 702. In step 806, the first MIMO FMCW radar transceiver 702 transmits the first FMCW chirps into an FOV independently of the second MIMO FMCW radar transceiver 704. In step 808, the second MIMO FMCW radar transceiver 704 transmits the second set of FMCW chirps into an FOV independently of the second MIMO FMCW radar transceiver 704.

In step 810, the first MIMO FMCW radar transceiver 702 receives signals from its FOV to generate first received signals independently of the second MIMO FMCW radar transceiver 704. In step 812, the second MIMO FMCW radar transceiver 704 receives signals from its FOV to generate second received signals independently of the first MIMO FMCW radar transceiver 702. In step 814, the first MIMO FMCW radar transceiver 702 performs range and Doppler FFTs on the first received signals to generate a first set of virtual antenna array signals independent of the second MIMO FMCW radar transceiver 704. In step 816, the second MIMO FMCW radar transceiver 704 performs range and Doppler FFTs on the second received signals to generate a second set of virtual antenna array signals independent of the first MIMO FMCW radar transceiver 704.

In step 818, the second MIMO FMCW radar transceiver 704 transmits the second set of virtual antenna array signals to the first MIMO FMCW radar transceiver 702. In some examples, transmitted virtual array signals correspond to range-Doppler spectral information, such as range-Doppler FFT information, of the second MIMO FMCW radar transceiver 704. In some examples, transmitted virtual array signals correspond to range-Doppler FFTs 420 for a corresponding data frame 116 or group of data frames 116. In step 820, the first MIMO FMCW radar transceiver 702 determines angle of arrival information with respect to one or more objects in the FOV in response to the first and second sets of virtual antenna array signals. In some examples, determining angle of arrival information in response to the first and second sets of virtual antenna array signals corresponds to performing an angle spectrum estimation, such as an angle FFT, using both sets of virtual antenna array signals. Accordingly, determining angle of arrival information corresponds to performing an angle FFT across a data set enlarged by inclusion of range-Doppler FFTs 420, or other range-Doppler spectral information, from both the first and second MIMO FMCW radar transceivers 702 and 704. In step 822, the first MIMO FMCW radar transceiver 702 uses determined range, Doppler, and angle of arrival information to detect an object and determine a corresponding point cloud (points in space determined to correspond to locations that reflected FMCW chirps).

In some examples, the first MIMO FMCW radar transceiver 702 independently determines angle with respect to objects in range 322 of the first MIMO FMCW radar transceiver 702 that are not within the shared FOV. In some examples, the second MIMO FMCW radar transceiver 704 independently determines angle with respect to objects in range 322 of the second MIMO FMCW radar transceiver 704 that are not within the shared FOV.

In some examples, the first and second MIMO FMCW radar transceivers 702 and 704 cach use a reference clock signal and a frame synchronization signal provided by the shared reference clock 712. Use of the shared reference clock 712 enables steps 802 through 816 to be performed by the first and second MIMO FMCW radar transceivers 702 and 704 independently of cach other.

In some examples (as further described with respect to FIG. 9, the first MIMO FMCW radar transceiver 702 sends a start time, an end time, and the frame synchronization signal to the second MIMO FMCW radar transceiver prior to step 804. This enables steps 802 through 816 to be performed by the first and second MIMO FMCW radar transceivers 702 and 704 independently of each other. In such examples, independent performance by the second MIMO FMCW radar transceiver 704 is subsequent and responsive to compensation, at the start of a respective data frame 116, for a frequency offset between the first reference clock 720 and the second reference clock 722,

FIG. 9 is a set of graphs 900 illustrating example differences between parameters of FMCW chirps to be transmitted by the multiple-transceiver FMCW radar system 700 of FIG. 7. The graphs 900 include a first graph 902, corresponding to first FMCW chirps 906 to be transmitted by the first FMCW transceiver 702, and a second graph 904, corresponding to second FMCW chirps 908 to be transmitted by the second FMCW transceiver 704. The vertical axes indicate frequency, and the horizontal axes indicate time. The first and second FMCW chirps 906 and 908 are numbered with subscripts, starting with 1, depending on an order in which they are to be transmitted. For example, the first graph 902 shows first FMCW chirps 906₁, 906₂, and 906₃, and the second graph 904 shows second FMCW chirps 908₁, 908₂, and 908₃. In an example, first and second FMCW chirps 906 and 908 have a designed starting frequency of 77 GHZ, a chirp duration of 20 microseconds, and a data frame duration of 15 milliseconds.

There is an inter-frame time T_{I-F}, corresponding to a difference between a start time of a data frame 910 of the first FMCW chirps 906 and a start time of a data frame 912 of the second FMCW chirps 908. The first FMCW chirps 906 have a start frequency f_{0A}, and the second FMCW chirps 908 have a start frequency f_{0B}. The first FMCW chirps 906 have a slope S_{A}, and the second FMCW chirps 908 have a slope S_{B}. The first FMCW chirps 906 have an inter-chirp time of T_{IC-A}, and the second FMCW chirps 908 have an inter-chirp time of T_{IC-B}.

Methods are described below for reducing phase errors introduced by differences between FMCW chirps and data frames 910 and 912 of FMCW chirps 906 and 908 of the first FMCW transceiver 702 and of the second FMCW transceiver 704, and by sampling differences of respective ADC circuits 318 of the first and second FMCW transceivers 702 and 704. These methods include methods for reducing T_{I-F}, and for reducing differences between f_{0A} and f_{0B}, between S_{A} and S_{B}, between T_{IC-A} and T_{IC-B}. Adjustments to sampling parameters of respective ADC circuits 318 are also described.

Transceiver timing synchronization is used to align frames of the first and second FMCW transceivers 702 and 704. In other words, transceiver timing synchronization is performed to align, in slow time, a set of FMCW chirps 908 of the second FMCW transceiver 704 with respect to a corresponding set of FMCW chirps 906 of the first FMCW transceiver 702, so that T_{I-F} is controlled. Transceiver timing synchronization aligns sets of FMCW chirps 908 of the second FMCW transceiver 704 to start at the same time as, or with a specified delay with respect to, corresponding sets of FMCW chirps 906 of the first FMCW transceiver 702.

In some examples, a non-zero T_{I-F} (for example, a T_{I-F} of a few microseconds) is specified to prevent the transmitted signals from the first and second FMCW transceivers 702 and 704 from interfering with one another. Data frame timing synchronization enables use of the virtual antennas 708 and 710 of both the first and second FMCW transceivers 702 and 704 to perform angle estimation with accuracy responsive to the cumulative number of virtual antennas. Data frame timing synchronization is performed using the frame synchronization pulse.

In some examples, to perform transceiver timing synchronization, the effects of a programmed non-zero value T_{I-F} are corrected using Doppler-based phase compensation. Doppler-based phase compensation corrects the phases of signals received by respective virtual antennas 710 of the second FMCW transceiver 704 with respect to virtual antennas 708 of the first FMCW transceiver 702 based on the Doppler of the respective signal. An uncompensated data frame start timing error in T_{I-F}, which can be caused by (for example) frame to frame variation in the delay of the frame synchronization pulse, is referred to herein as δ_{synch}.

This uncompensated frame start timing error δ_{synch} can cause an error ϕₑᵣᵣ in the phase of the signal virtual antennas given by ϕₑᵣᵣ=4πυδ_{synch}/λ, where v is the target velocity (velocity corresponding to an amplitude spike 422 in the range-Doppler FFT 420) and λ is the average wavelength of an FMCW chirp 102 (for example, 77.5 GHZ for an FMCW chirp 102 with F₀=77 GHz and F₁=78 GHZ). Accordingly, in some examples, synchronization as described herein can tolerate frame start timing error δ_{synch} of a few hundred nanoseconds (ns). For example, given a maximum velocity of an object in range 322 of 100 kilometers per hour, and a budgeted error contribution from δ_{synch} of less than 1°, the δ_{synch} across devices is approximately 200 ns or less. (In some examples, angular error contributions described herein correspond to phase errors in frequency bins of corresponding range-Doppler FFTs 420 that include amplitude spikes 422.)

As described above, an example method of synchronizing multiple FMCW transceivers to perform object detection uses a shared reference signal, such as a 40 MHz clock. The first FMCW transceiver 702 and the second FMCW transceiver 704 each use the shared reference signal to internally generate the chirp signal, ADC timing signals, and inter-chirp timing signals Using a shared reference signal enables automatic synchronization of certain parameters such as start frequency, chirp slope, ADC start time, and inter-chirp time.

An alternate approach to timing synchronization uses the precise time protocol (PTP) that is supported in some Ethernet implementations. In some examples, this approach is used in cases where use of a shared reference signal is unavailable, or where an Ethernet connection is available. In some examples, another communication protocol is used that similarly enables precise timestamps or otherwise enables precise timing determinations of a start time and an end time between which a specified number of clock cycles are generated by a reference clock. In some examples, usage of Ethernet-PTP (or similar) enables avoiding usage of a shared reference clock. In some examples, usage of Ethernet-PTP for synchronization enables synchronization where transceivers are not collocated (e.g., in large baseline arrays), or are using Ethernet for data transfer (e.g., in a satellite radar architecture). Synchronization using Ethernet-PTP (or similar) can be performed as follows.

In examples in which Ethernet-PTP is used for timing synchronizations, the first and second FMCW transceivers 702 and 704 each use an independent reference clock, such as a 40 MHz clock. In some examples, these independent reference clocks, though operating at the same nominal frequency, have different instantaneous drifts in frequency. A drift between the reference clock of the first FMCW transceiver 702 and the reference clock of the second FMCW transceiver 704 is determined, as follows. This drift is referred to as a (read as alpha) of the reference clock 722 of the second FMCW transceiver 704 with respect to the reference clock 720 of the first FMCW transceiver 702. In some examples, the reference clock frequency drift a is caused by pressure, voltage, or temperature variations.

In some examples, Ethernet-PTP can provide timestamps accurate to within 100 ns or less. In some examples, an acceptable maximum latency of transmission of the timestamps is responsive to a minimum acceptable accuracy of range-Doppler information used for angle of arrival determination. Two Ethernet-PTP timestamps, separated by T seconds, are provided by the first FMCW transceiver 702 to the second FMCW transceiver 704. The second FMCW transceiver 704 measures a number of cycles of its reference clock that elapse between receiving the first timestamp and receiving the second timestamp. This enables the second FMCW transceiver 704 to determine the frequency drift α of the reference clock 722 of the second FMCW transceiver 704 with respect to the reference clock 720 of the first FMCW transceiver 702 to within (2×Acc)/T. where Acc is the accuracy of the timestamps. For example, if T equals 4 seconds and the timestamps as received by the second FMCW transceiver 704 are each accurate to within 100 ns (Acc=100 ns), then the drift α of the reference clock 722 of the second FMCW transceiver 704 with respect to the reference clock 720 of the first FMCW transceiver 702 can be determined with an accuracy of (2×100 ns)/4=0.05 parts per million (ppm). In some examples, the reference clock frequency drift a is determined as shown in Equation 1:

$$α = \frac{( {N}_{b} - {N}_{a} )}{{N}_{a}} \qquad Equation 1$$

In Equation 1, Nₐ is the number of clock cycles of the reference clock 720 of the first FMCW transceiver 702 that pass between the first timestamp and the second timestamp. N_{b} is the number of clock cycles of the reference clock 722 of the second FMCW transceiver 704 that pass between the first timestamp and the second timestamp.

In some examples, the second FMCW transceiver 704 is modified (e.g., programmed) to compensate for this frequency drift α, as further described below: the start frequency (f_{0B}) is modified to be equal to the start frequency (f_{0A}) of the first FMCW transceiver 702. (Start frequency refers to the base frequency F₀ 106 of the signal to be transmitted by each respective transmitter.) An ADC sampling frequency is modified. A start time for sampling of an IF signal by an ADC circuit 318 following a corresponding FMCW chirp 102 (an ADC start time) of the second FMCW transceiver 704 is compensated for or corrected. T_{IC-B} (inter-chirp time) is modified for each second FMCW chirp 908 in a data frame 116, after an initial second FMCW chirp 908₁ of the data frame 116, to align (in some examples, as closely as possible) to the T_{IC-A} of corresponding first FMCW chirps 906. The inter-frame period 120 of the second FMCW transceiver 704 is adjusted to be aligned to the inter-frame period 120 of the first FMCW transceiver 702.

The phase of the signal at a virtual antenna is sensitive to start frequency (F₀ 106) differences between transmitting devices. (After FFT processing, a signal at a virtual antenna is represented within a corresponding frequency bin as a complex number. The phase of the signal refers to the phase of that complex number.) Accordingly, in some examples, for can be corrected with respect to f_{0A} as follows. Let α (read as alpha) denote the drift of the reference clock of transceiver 704 with respect to the reference clock of transceiver 702, as determined using (for example) Ethernet-PTP signals. Accordingly, the second FMCW transceiver 704 incorporates an additional frequency offset of αf_{0A} by programming f_{0B} as shown in Equation 2:

f_{0B_programmed}=f_{0A}+αf_{0A} Equation 2

In Equation 2, for is the desired start frequency and f_{0B_programmed} is the programmed start frequency of the specific transmitter 206. As described above, the second FMCW transceiver 704 has a reference clock drift of a with respect to the first FMCW transceiver 702. This causes the starting frequency of the second FMCW transceiver 704 to drift by −αf_{0A}. Accordingly, a programmed value of f_{0B_programmed} enables the actual start frequency of a transmitted FMCW chirp 908 of the second FMCW transceiver 704 to match the start frequency f_{0A} of a transmitted FMCW chirp 906 of the first FMCW transceiver 702, as the frequency drift and the programmed offset cancel each other out.

In some examples, estimation of reference frequency drift α and correction according to Equation 2 may leave a residual, uncorrected reference clock drift of αᵣₑₛ (measured in ppm). This residual reference clock drift results in a residual phase error θₑᵣᵣ₋ᵣₑₛ given by Equation 3:

$${θ}_{e r r - r e s} = \frac{4 π {f}_{0 A} {α}_{r e s} d}{c} \qquad Equation 3$$

In Equation 3, f_{0A} is the starting frequency of the FMCW chirp 906 transmitted by the first FMCW transmitter 702 expressed in Hz, d is the distance to the object in range 322, and c is the speed of light. In some examples, f_{0A} equals 77 GHZ and d equals 100 meters, so that knowledge of α to within 0.1 ppm (that is, αᵣₑₛ=0.1 ppm) enables a residual phase error θₑᵣᵣ₋ᵣₑₛ of less than 2°. Accordingly, accurate knowledge of reference clock drift α enables correction of the start frequency of the second FMCW transceiver 704 to enable reduction in residual phase error. In some examples, a programming granularity available in an FMCW transceiver to be adjusted (i.e., the first or second FMCW transceiver 702 or 704) provides fine tuning of start frequency f_{0B_programmed} to enable start frequency accuracy on the order of 10⁻³ ppm or better.

A sampling rate of the ADC circuit(s) 318 of the second FMCW transceiver 704 can be modified to correct for the drift α of its reference clock 722 with respect to the reference clock 720 of the first FMCW transceiver 702. In some examples, an ADC sampling rate can be modified to correct for α as follows. For an object in range 322 at range d, the digitized IF frequency Ω_{IF} without reference clock drift (α=0) is given by Equation 4, in which S is the slope of the FMCW chirp 102 frequency (frequency change divided by ramp time) and T_{S} is the ADC sampling period:

$${ω}_{IF} = \frac{4 π {SdT}_{S}}{c} \qquad Equation 4$$

A ppm reference clock drift of α results in a corresponding digitized IF frequency of (1+α)×Ω_{IF}, so that actual digitized IF frequency deviates from ideal digitized IF frequency by αΩ_{IF}. This IF frequency deviation αΩ_{IF} can cause a gain and phase mismatch between corresponding range bins across virtual antennas of different transceivers. For example, the IF frequency deviation αΩ_{IF} can cause a gain and phase mismatch between corresponding cells that include amplitude spikes 422 of the Tx1-Rx1 and Tx3-Rx3 range-Doppler FFTs 420 (see FIG. 5), where (for this example) Tx1-Rx1 is a virtual antenna of the first FMCW transceiver 702, and Tx3-Rx3 is a virtual antenna of the second FMCW transceiver 704. The IF frequency deviation-related phase mismatch θₑᵣᵣ₋ₘₘ is determined as shown in Equation 5:

$${θ}_{e r r - m m} = \frac{α {ω}_{I F} {N}_{A D C}}{2} \qquad Equation 5$$

In Equation 5, N_{ADC} is the number of samples the ADC circuit(s) 318 measures per FMCW chirp 102, which equals FMCW chirp duration (ramp time 104) divided by T_{S}. In an example, where NADC equals 256 and a equals 200 ppm, θₑᵣᵣ₋ₘₘ is approximately 10°.

The phase mismatch θₑᵣ₋ₘₘ can be corrected for by modifying (e.g., programming) the sampling period T_{S} of the second FMCW transceiver 704 as shown in Equation 6, in which T_{S-MOD} is the modified sampling period:

T_{S-MOD}=(1−α)×T_{S} Equation 6

In some examples, a sampling rate programming granularity of one thousand samples per second (Δ_{IF}=1 Ksps) is sufficient to reduce phase mismatch error θₑᵣᵣ₋ₘₘ to 1°.

ADC start time refers to the time delay between the start of transmission of a chirp and the first subsequent ADC sampling instant. In some examples, an ADC start time of the second FMCW transceiver 704 can be corrected with respect to an ADC start time of the first FMCW transceiver 702 as follows. An ADC start time of Tₛₜₐᵣₜ contributes a phase of 2πf_{IF}Tₛₜₐᵣₜ in the virtual antenna signal, where f_{IF} is the IF frequency. Here, the virtual antenna signal refers to the signal value in the range-Doppler FFT 420 corresponding to the virtual antenna; for example, Tx1-Rx1 in FIG. 5.

Making this phase contribution (2πf_{IF}Tₛₜₐᵣₜ) identical (or as close as possible) across the virtual antennas of the first and second FMCW transceivers 702 and 704 facilitates accurate angle estimates. That is, differences in the ADC start time cause phase differences that can cause angle estimation error. In some examples, a drift a between the reference clocks 720 and 722 of the first and second FMCW transceivers 702 and 704 corresponds to an ADC sampling-related phase mismatch of 2πf_{IF}αTₛₜₐᵣₜ. In some examples, this phase mismatch can be compensated for in multiple ways.

First, the phase mismatch is dependent on the IF frequency; the IF frequency corresponds to a range bin 414 of the range-FFT 412. The phase mismatch can be corrected by performing a phase rotation on the signal value in the corresponding range bin 414 of the range-FFT 412 on the virtual antennas 710 of the second FMCW transceiver 704. (In some examples, on all the virtual antennas 710 of the second FMCW transceiver 704.) This phase rotation is achieved by multiplying the signal value in the range bin 414 by e^{-j2πf}^{_{IF}}^{αT}^{ₛₜₐᵣₜ}, where j is the square root of −1. In some examples, if a is known to within 0.1 ppm, using a phase rotation per range bin 414 results in reducing ADC sampling-related phase mismatch to or near zero.

An alternative, second method of compensating for phase mismatch related to ADC start time includes modifying (e.g., reprogramming) the ADC start time of the second FMCW transceiver 704. In some examples, assuming maximum IF frequency of 20 MHz, an ADC start time resolution of 0.55 ns is sufficient to enable a residual IF frequency-related phase mismatch, after phase correction, of approximately 2° or less.

In some examples, T_{IC-B} can be corrected with respect to T_{IC-A}. The intended (for example, programmed) start times of first and second FMCW chirps 906 and 908 are n× T_{IC-A} (intended to be the same), where n is an integer that iterates from zero to (N_{chirps}−1), and where N_{chirps} is the number of FMCW chirps in a frame of FMCW chirps to be transmitted by the first FMCW transceiver 702. However, the reference clock frequency drift a causes an inter-chirp timing difference in the second FMCW transceiver 704, so that T_{IC-B}, prior to correction, equals n×(1−α)×T_{IC-A}. The inter-chirp timing difference n×α×T_{IC-A} can result in phase mismatch between virtual antennas of the first FMCW transceiver 902 and virtual antennas of the second FMCW transceiver 904 after the Doppler FFT (step 418).

In a first example approach to correcting T_{IC-B}, the inter-chirp time can be modified (e.g., programmed). The inter-chirp time T_{IC-B} can be modified with a granularity of Δ(T_{IC}), such that if the device is programmed with an integer value of L, it results in an inter-chirp time of LΔ(T_{IC}). (In some examples, Δ(T_{IC}) equals 10 ns.) The inter-chirp time on the secondary device can be programmed as follows. First, a sequence M(n) of integers is determined as shown in Equation 7:

$$M ( n ) = round ( \frac{n {T}_{I C - A}}{( 1 - α ) Δ ( {T}_{IC} )} ) , n = 0 , 1 , 2 , {N}_{chirps} - 1 \qquad Equation 7$$

Next, a subsequent set of integers L(n) is determined as shown in Equation 8:

L(n)=M(n)−M(n−1), n=1,2 3, . . . N_{chirps}−1 Equation 8

In Equation 8, L(n) represents an integer value to be programmed into the second FMCW transceiver 704 to control the inter-chirp time T_{IC-B} between the n^{th} chirp and the (n−1)^{th} chirp of a corresponding data frame 116. Accordingly, the inter-chirp time T_{IC-B} as expressed by digital control using L(n) will be Δ(T_{IC})×L(n).

In some examples, there will be a residual error in the inter-chirp time, such as a residual error that varies between ±5 ns. This residual error can be viewed as phase noise, which will result in a noise floor (a minimum noise amplitude) after the Doppler FFT. In some examples, this noise floor will be approximately 70 dB relative to the carrier (dBc).

In a second example approach to correcting T_{IC-B}, a residual error remaining after applying the first example approach can be corrected by adjusting f_{0B}. Note that a change in start frequency by Δf_{c} is equivalent to a time adjustment of Δf_{c}/S_{B}. In an example, the start frequency can be programmed with a granularity of 100 Hz or less, with a slope of S_{B}=10 MHz/μs. In the example, the granularity of the equivalent time adjustment of T_{IC-B} will be 100/10e12=10 picoseconds (ps).

In some examples, compensation for the reference clock frequency drift a as described herein is performed prior to step 804 of the process 800 of FIG. 8.

Modifications are possible in the described embodiments, and other embodiments are possible, within the scope of the claims.

In some examples, a processing circuit other than a DSP is used, such as a central processing unit (CPU).

In some examples, a spectral estimation technique other than FFT is used to perform range, range-Doppler, and angle spectral estimations, such as Bartlett Beamformer or Minimum Variance Distortionless Response (MVDR) Beamformer.

In some examples, providing range-Doppler spectral information is sufficient to convey corresponding virtual antenna information.

In some examples, virtual antenna array signals are provided from both the first FMCW transceiver 702 and the second FMCW transceiver 704 to a processor (such as a processor at the shared reference clock 712) for processing to determine angle information.

In some examples, virtual antenna array signals are provided from the first FMCW transceiver 702 to the second FMCW transceiver 704.

In some examples, the first reference clock 720 is generated independently of the second FMCW transceiver 704. In some examples, the second reference clock is generated independently of the first FMCW transceiver 702. In some examples, the shared reference clock 712 is generated independently of the first and second FMCW transceivers 702 and 704.

In some examples, a frequency modulated continuous wave (FMCW) radar includes a reference clock configured to generate a reference clock signal; an FMCW signal generator configured to generate FMCW chirps; an analog to digital converter (ADC) configured to receive FMCW signals, and to sample the FMCW signals in response to the reference clock signal to generate FMCW signal samples; and a processor configured to: determine a frequency drift in response to the reference clock signal, the start time, and the end time; determine, in response to the frequency drift, at least one of: an ADC start time, a start frequency of respective ones of the FMCW chirps, a chirp slope of respective ones of the FMCW chirps, or respective inter-chirp times between respective ones of the FMCW chirps; receive the FMCW signal samples; and determine a set of virtual antenna signals in response to the FMCW signal samples.

In this description, the term “and/or” (when used in a form such as A, B and/or C) refers to any combination or subset of A, B, C, such as: (a) A alone; (b) B alone; (c) C alone; (d) A with B; (e) A with C; (f) B with C; and (g) A with B and with C. Also, as used herein, the phrase “at least one of A or B” (or “at least one of A and B”) refers to implementations including any of: (a) at least one A; (b) at least one B; and (c) at least one A and at least one B.

A device that is “configured to” perform a task or function may be configured (for example, programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

A circuit or device that is described herein as including certain components may instead be adapted to be coupled to those components to form the described circuitry or device. For example, a structure described as including multiple functional blocks may instead include only the functional blocks within a single physical device (for example, a semiconductor die and/or integrated circuit (IC) package) and may be adapted to be coupled to at least some of the functional blocks to form the described structure either at a time of manufacture or after a time of manufacture, for example, by an end-user and/or a third-party.

Circuits described herein are reconfigurable to include the replaced components to provide functionality at least partially similar to functionality available prior to the component replacement.

The term “couple” is used throughout the specification. The term may cover connections, communications, or signal paths that enable a functional relationship consistent with this description. For example, if device A provides a signal to control device B to perform an action, in a first example device A is coupled to device B, or in a second example device A is coupled to device B through intervening component C if intervening component C does not substantially alter the functional relationship between device A and device B such that device B is controlled by device A via the control signal provided by device A.

While certain elements of the described examples may be included in an IC and other elements are external to the IC, in other examples, additional or fewer features may be incorporated into the IC. In addition, some or all of the features illustrated as being external to the IC may be included in the IC and/or some features illustrated as being internal to the IC may be incorporated outside of the IC. As used herein, the term “IC” means one or more circuits that are: (i) incorporated in/over a semiconductor substrate; (ii) incorporated in a single semiconductor package; (iii) incorporated into the same module; and/or (iv) incorporated in/on the same PCB.

Unless otherwise stated, “about,” “approximately,” or “substantially” preceding a value means +/−10 percent of the stated value, or, if the value is zero, a reasonable range of values around zero.

What is claimed is:

1. A frequency modulated continuous wave (FMCW) radar system, comprising:
a first FMCW device that includes a processor configured to receive a first set of FMCW signals corresponding to a field of view (FOV), and to process the first set of FMCW signals, to generate a first set of range-Doppler spectral information; and
the second FMCW device that includes a processor configured to receive a second set of FMCW signals corresponding to the FOV, and to process the second set of FMCW signals, to generate a second set of range-Doppler spectral information;
wherein the second FMCW device is configured to transmit the second set of range-Doppler spectral information to the first FMCW device; and
wherein the processor of the first FMCW device is configured to determine angle of arrival information with respect to one or more objects in the FOV in response to the first and second sets of range-Doppler spectral information.

2. The FMCW radar system of claim 1, wherein the first and second sets of range-Doppler spectral information are generated using one or more of Fast Fourier Transform (FFT), Bartlett Beamformer, or Minimum Variance Distortionless Response (MVDR) Beamformer.

3. The FMCW radar system of claim 1, wherein the processor of the second FMCW device is configured to perform Doppler compensation with respect to a deliberately included difference in transmission time between FMCW chirps corresponding to the first set of range-Doppler spectral information and FMCW chirps corresponding to the second set of range-Doppler spectral information.

4. A frequency modulated continuous wave (FMCW) radar system, comprising:
a first FMCW device, the first FMCW device including:
a first FMCW synthesizer configured to generate first FMCW chirps;
multiple transmitters configured to transmit the first FMCW chirps into a field of view (FOV);
multiple receivers configured to receive signals from the FOV to generate first received signals; and
a processor configured to process the first received signals, independently of a second FMCW device, to generate a first set of virtual antenna array signals; and
the second FMCW device configured to couple to the first FMCW device, the second FMCW device including:
a second FMCW synthesizer configured to generate second FMCW chirps;
multiple transmitters configured to transmit the second FMCW chirps into the FOV;
multiple receivers configured to receive signals from the FOV to generate second received signals; and
a processor configured to process the second received signals, independently of the first FMCW device, to generate a second set of virtual antenna array signals;
wherein the second FMCW device is configured to transmit the second set of virtual antenna array signals to the first FMCW device; and
wherein the first FMCW device is configured to use the first and second sets of virtual antenna array signals to determine angle of arrival information with respect to one or more objects in the FOV.

5. The FMCW radar system of claim 4,
further comprising a shared reference clock circuit configured to couple to the first FMCW device and to the second FMCW device, the shared reference clock circuit configured to generate a reference clock signal and to provide the reference clock signal to the first and second FMCW devices;
wherein the first FMCW device and the second FMCW device are both configured to use the reference clock signal to determine one or more of: a start frequency of respective FMCW chirps, a chirp slope of respective FMCW chirps, respective analog-to-digital converter (ADC) start times, or respective inter-chirp times.

6. The FMCW radar system of claim 4,
wherein the first FMCW synthesizer includes a reference signal generator configured to generate a first reference clock signal, the first FMCW synthesizer configured to generate the first FMCW chirps in response to the first reference clock signal; and
wherein the second FMCW device includes a reference signal generator configured to generate a second reference clock signal, the second FMCW synthesizer configured to generate the second FMCW chirps in response to the second reference clock signal.

7. The FMCW radar system of claim 6,
wherein the first FMCW device is configured to transmit a start time and an end time to the second FMCW device; and
wherein the second FMCW device is configured to, in response to a number of clock cycles between the start time and the end time, determine one or more of: a start frequency of respective FMCW chirps, a chirp slope of respective FMCW chirps, respective analog-to-digital converter (ADC) start times, or respective inter-chirp times.

8. The FMCW radar system of claim 7, wherein the start time and the end time correspond to Ethernet-PTP timestamps.

9. The FMCW radar system of claim 4,
wherein the first FMCW device is configured to provide a synchronization pulse to the second FMCW device; and
wherein the second FMCW device is configured to determine a data frame start time in response to the synchronization pulse.

10. A method for detecting an object, the method comprising:
generating, using a first frequency modulated continuous wave (FMCW) device and responsive to a first reference clock generated independently of a second FMCW device, a first set of FMCW chirps;
transmitting, using the first FMCW device and responsive to the first reference clock, the first FMCW chirps into a field of view (FOV);
receiving, using the first FMCW device, signals from the FOV to generate first received signals; and
processing the first received signals, responsive to the first reference clock, to generate a first set of virtual antenna array signals;
generating, using the second FMCW device and responsive to a second reference clock generated independently of the first FMCW radar device, a second set of FMCW chirps;
transmitting, using the second FMCW device and responsive to the second reference clock, the second FMCW chirps into the field of view (FOV);
receiving, using the second FMCW device, signals from the FOV to generate second received signals; and
processing the second received signals, responsive to the second reference clock, to generate a second set of virtual antenna array signals;
transmitting, from the second FMCW device to the first FMCW device, the second set of virtual antenna array signals; and
determining, using the first FMCW device, angle of arrival information with respect to one or more objects in the FOV in response to the first and second sets of virtual antenna array signals.

11. The method of claim 10,
wherein the first set of virtual antenna array signals includes a first range-Doppler spectral estimation; and
wherein the second set of virtual antenna array signals includes a second range-Doppler spectral estimation.

12. The method of claim 10, further including performing, using the second FMCW device, Doppler compensation with respect to a deliberately included difference in transmission time between FMCW chirps corresponding to the first set of virtual antenna array signals and FMCW chirps corresponding to the second set of virtual antenna array signals.

13. The method of claim 10, further comprising:
providing a shared reference clock signal to the first FMCW device and to the second FMCW device;
wherein the first FMCW device and the second FMCW device are both configured to use the reference clock signal to determine one or more of: a start frequency of respective FMCW chirps, a chirp slope of respective FMCW chirps, respective analog-to-digital converter (ADC) start times, or respective inter-chirp times.

14. The method of claim 10, further comprising:
generating, using the first FMCW device, a first reference clock signal, wherein the first FMCW device generates the first FMCW chirps in response to the first reference clock signal; and
generating, using the second FMCW device, a second reference second reference clock signal, wherein the second FMCW device generates the second FMCW chirps in response to the second reference clock signal.

15. The method of claim 14, further comprising providing, by the first FMCW device to the second FMCW device, a start time and an end time;
wherein the second FMCW device is configured to, in response to a number of clock cycles between the start time and the end time, determine one or more of: a start frequency of respective FMCW chirps, a chirp slope of respective FMCW chirps, respective analog-to-digital converter (ADC) start times, or respective inter-chirp times.

16. The method of claim 15, wherein the start time and the end time correspond to Ethernet-PTP timestamps.

17. The method of claim 10, further comprising:
providing a synchronization pulse from the first FMCW device to the second FMCW device; and
determining a data frame start time, using the second FMCW device, in response to the synchronization pulse.

18. A frequency modulated continuous wave (FMCW) radar, comprising:
a reference clock configured to generate a reference clock signal;
an analog to digital converter (ADC) configured to receive FMCW signals, and to sample the FMCW signals in response to the reference clock signal to generate FMCW signal samples; and
a processor configured to:
provide a start time and an end time to another FMCW radar in response to the reference clock signal;
receive the FMCW signal samples;
determine a first set of virtual antenna signals in response to the FMCW signal samples;
receive a second set of virtual antenna signals from the another FMCW radar; and
determine an angle of arrival in response to the first and second sets of virtual antenna signals.

19. The FMCW radar of claim 18, wherein the first set of virtual antenna signals include a first set of range-Doppler spectral estimations corresponding to the FMCW signal samples, and the second set of virtual antenna signals include a second set of range-Doppler spectral estimations that do not correspond to the FMCW signal samples.

20. The FMCW radar of claim 19, wherein the first and second sets of range-Doppler spectral estimations are generated using one or more of Fast Fourier Transform (FFT), Bartlett Beamformer, or Minimum Variance Distortionless Response (MVDR) Beamformer.
